(19) United States
(12) Patent Application Publication
(10) Pub. No.: US 2011/0265767 A1
(43) Pub. Date: Nov. 3, 2011

(54) ISOLATER FOR FUEL INJECTOR

(75) Inventors: WENBIN XU, PITTSFORD, NY (US); CHARLES W. BRAUN, LIVONIA, NY (US); ROBERT B. PERRY, LEICESTER, NY (US); Vicki A. Flynn, Penfield, NY (US)

(73) Assignee: DELPHI TECHNOLOGIES, INC., TROY, MI (US)

(21) Appl. No.: 13/097,444

(22) Filed: Apr. 29, 2011

Related U.S. Application Data
(60) Provisional application No. 61/330,629, filed on May 3, 2010.

(51) Int. Cl. F02M 61/14

(52) U.S. Cl. 123/470

(57) ABSTRACT

A fuel injector-engine component assembly includes an engine component with a stepped bore defined along an axis and having a stepped bore stop surface facing axially upward. A fuel injector extending along the axis is disposed in the stepped bore and includes a fuel injector stop surface facing axially downward and axially opposing the stepped bore stop surface. An isolation ring is disposed between the engine component and fuel injector stop surfaces for axially isolating the fuel injector from the engine component. The isolation ring includes a rigid support member for limiting the axial motion of the engine component and fuel injector stop surfaces together. The isolation ring also includes a resilient and compliant isolation member located axially between the engine component and fuel injector stop surfaces to provide acoustic and thermal isolation between the fuel injector and the engine component below a predetermined pressure of the fuel injector.

### CROSS-REFERENCE TO RELATED APPLICATIONS

This application claims the benefit of U.S. provisional patent application Ser. No. 61/330,629 filed May 3, 2010, the disclosure of which is hereby incorporated by reference in its entirety.

### TECHNICAL FIELD OF INVENTION

The present invention relates to fuel injection systems of internal combustion engines; more particularly, to fuel injectors for direct injection; and most particularly to a device for acoustic and thermal isolation of a fuel injector from a cylinder head.

### BACKGROUND OF INVENTION

Fuel injector systems that deliver fuel to the combustion chamber of an internal combustion engine have been known for many years. The typical fuel injection system draws fuel from a fuel tank to a fuel rail mounted adjacent to the cylinder bank of the engine. The fuel injectors are electro-mechanical devices that deliver fuel in precise amounts and times to the respective cylinder.

While the engine is running, the valve within each fuel injector is constantly being operationally cycled from an opened to a closed position. Vibration is generated by the mechanical movement of the injector valves and pressure waves are generated by the movement of the fuel flowing through the injectors. Additionally, a substantial amount of heat generated in the combustion chambers of the cylinder heads may be transferred from the engine to the fuel injector.

In an engine having a direct injection fuel injector, atomized fuel is sprayed by the injector directly into the combustion chamber of the engine. The fuel injector tip portion of the direct injection fuel injector typically fits through a stepped bore defined in the cylinder head that has a peripheral bottom shoulder whose top surface provides a positive stop to the bottom surface of the body of the direct injection fuel injector. However, direct metal-to-metal contact between the bottom surface of the direct injection fuel injector body and the top surface of the shoulder allows for unmitigated transfer of the vibration from the direct injection fuel injector to the cylinder head and allows for the transfer of heat by thermal conduction from the cylinder head to the direct injection fuel injector. Noise created thereby can be particularly objectionable at engine idling and low load operation. Additionally, allowing the vibration from the direct injection fuel injector to propagate into the combustion chamber can adversely effect the placement of the highly precise fuel spray pattern into the combustion chamber. Moreover, allowing thermal conduction of heat from the cylinder head to the direct injection fuel injector can lead to injector tip plugging thereby affecting fuel metering and injector spray pattern.

Prior attempts to isolate vibration and heat transfer between the direct injection fuel injector and the cylinder head have included, for example, the installation of a full-fitting isolation spacer between the bottom surface of the body of the direct injection fuel injector and the shoulder in the cylinder head bore such as a plastic ring on top of a metal ring or a rubber encapsulated metal ring. However, the high downward compressive pressure exerted on these existing rings and their plastic or rubber isolation materials during normal engine operation causes the materials to creep around the engaging surfaces, effectively reducing the isolation materials between the direct injection fuel injector and the cylinder head. The use of compliant materials may also result in excessive axial movement between the direct injection fuel injector and the cylinder head which can adversely effect the placement of the highly precise fuel spray pattern into the combustion chamber thereby causing combustion problems. Excessive axial movement between the direct injection fuel injector and the cylinder head can also cause detrimental wear to the seal member between the direct injection fuel injector and the cylinder head which seals the combustion chamber from the atmosphere.

What is needed in the art is a method for effectively thermally and acoustically isolating the fuel injector from the cylinder head of an internal combustion engine. What is also needed is method for limiting compression of a compliant isolation member used to isolate the fuel injector from the cylinder head.

### SUMMARY OF THE INVENTION

A fuel injector-engine component assembly for an internal combustion engine is provided. The fuel injector-engine component assembly includes an engine component with a stepped bore defined along an axis. The stepped bore includes a stepped bore stop surface facing axially upward. A fuel injector is disposed in the stepped bore and extends along the axis. The fuel injector includes a fuel injector stop surface facing axially downward and axially opposing the stepped bore stop surface to define a predetermined annular space. In operation, the fuel injector is subjected to axial pulses that tend to drive the fuel injector stop surface and the stepped bore stop surface together. An isolation ring is disposed in the predetermined annular space and axially between the stepped bore stop surface and the fuel injector stop surface for axially isolating the fuel injector from the engine component. The isolation ring includes a rigid support member for limiting the axial motion of the stepped bore stop surface and the fuel injector stop surface together to a predetermined, limited degree. The isolation ring also includes a resilient and compliant isolation member located axially between the stepped bore stop surface and the fuel injector stop surface. The isolation member has sufficient resilience, compressibility, and insulative potential to provide at least one of acoustic and thermal isolation between the fuel injector and the cylinder head below a predetermined pressure of the fuel injector.

### BRIEF DESCRIPTION OF DRAWINGS

This invention will be further described with reference to the accompanying drawings in which:

FIG. 1 is a cross section of an isolation ring in accordance with the present invention installed in a cylinder head-fuel injector assembly;

FIG. 2A is an elevation view of a first embodiment of an isolation ring in accordance with the present invention;

FIG. 2B is a cross section of the first embodiment of an isolation ring in accordance with the present invention;

FIG. 2C is an isometric view of the first embodiment of an isolation ring in accordance with the present invention;

FIG. 2D is a second isometric view of the first embodiment of an isolation ring in accordance with the present invention;

FIG. 3A is an isometric view of a second embodiment of an isolation ring in accordance with the present invention;

FIG. 3B is a cross section of the second embodiment of an isolation ring in accordance with the present invention;

FIG. 4 is a cross section of a third embodiment of an isolation ring in accordance with the present invention;

FIG. 5 is a cross section of a fourth embodiment of an isolation ring in accordance with the present invention;

FIG. 6 is a cross section of a fifth embodiment of an isolation ring in accordance with the present invention;

FIG. 7 is a cross section of a sixth embodiment of an isolation ring in accordance with the present invention;

FIG. 8 is a cross section of a seventh embodiment of an isolation ring in accordance with the present invention installed in a cylinder head-fuel injector assembly;

FIG. 9 is a cross section of an eighth embodiment of an isolation ring in accordance with the present invention installed in a cylinder head-fuel injector assembly; and

FIG. 10 is a cross section of a ninth embodiment of an isolation ring in accordance with the present invention installed in a cylinder head-fuel injector assembly.

### DETAILED DESCRIPTION OF INVENTION

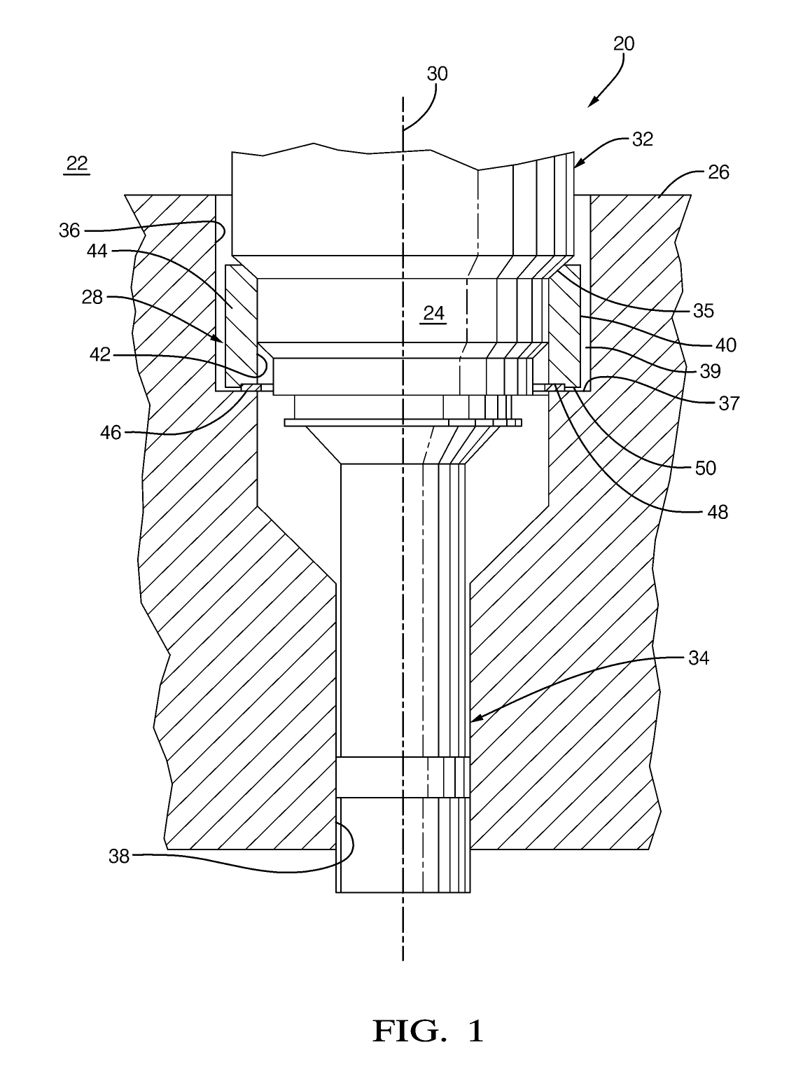

Referring to FIG. 1, a fuel-injector-engine component assembly illustrated as fuel injector-cylinder head assembly 20 of internal combustion engine 22 includes fuel injector 24, an engine component illustrated as cylinder head 26, and isolation ring 28 assembled therebetween. Fuel injector-cylinder head assembly 20 extends along an axis 30.

Fuel injector 24 extends along axis 30 and includes solenoid housing 32 and injector tip 34 axially extending from solenoid housing 32. Solenoid housing 32 includes fuel injector stop surface 35 facing axially downwardly. Cylinder head 26 includes stepped bore 36 defined along axis 30 and having stepped bore stop surface 37 facing axially upwardly and center opening 38. Fuel injector 24 is assembled in stepped bore 36 of cylinder head 26 such that stepped bore 36 of cylinder head 26 accommodates solenoid housing 32 of fuel injector 24 and such that injector tip 34 extends through center opening 38 of cylinder head 26. When fuel injector 24 is assembled within stepped bore 36, fuel injector stop surface 35 and stepped bore stop surface 37 axially oppose each other and define predetermined annular space 39. In operation, fuel injector 24 is subject to high frequency vibrations or axial pulses that tend to drive fuel injector stop surface 35 and stepped bore stop surface 37 axially together. Fuel injector 24 may be, but is not limited to, a fuel injector for direct injection as shown in FIG. 1.

Isolation ring 28 is positioned within stepped bore 36 such that isolation ring 28 is positioned adjacent to solenoid housing 32 and encircling fuel injector 24 within predetermined annular space 39. Accordingly, isolation ring 28 has outer circumference 40 that fits into stepped bore 36 and that is wider than center opening 38. Isolation ring 28 further includes center aperture 42 adapted to receive fuel injector 24 therethrough. Isolation ring 28 includes rigid support member 44 and isolation member 46. Support member 44 may be made of any material that is capable of withstanding the axial loads provided by fuel injector 24 while in operation and is preferably made of metal. Isolation member 46 is a compliant, resilient material and may be a rubber material such as fluorocarbon. Although not shown, it should now be understood that support member 44 may be formed integrally with fuel injector 24 or formed separately and attached to fuel injector 24.

Support member 44 includes recess 48 extending axially into support member 44 from first surface 50. Before isolation ring 28 is assembled into fuel injector-head assembly 20, isolation member 46 is in an uncompressed or free state. In the uncompressed state, isolation member 46 extends axially outward from first surface 50. For example, isolation member 46 may extend axially outward from first surface 50 a distance of about 1 millimeter. When isolation ring 28 is installed into fuel injector-head assembly 20, but not yet subjected to fuel pressure load from fuel injector 24, isolation member 46 may be compressed slightly. For example, isolation member 46 may now be compressed such that isolation member 46 may extend axially outward from first surface 50 a distance of about 0.4 millimeters. Isolation member 46 may be compressed further when internal combustion engine 22 is running at low to moderate loads, thereby requiring lower fuel pressure than the maximum fuel pressure it is capable of realizing. For example, isolation member 46 may now be compressed such that isolation member 46 may extend axially outward from first surface 50 a distance of about 0.1-0.2 millimeters. When internal combustion engine 22 is running at higher loads, thereby requiring higher fuel pressure than at lower loads, isolation member 46 may now be compressed such that isolation member 46 no longer extends axially outward from first surface 50. In other words, first surface 50 is now in contact with stepped bore stop surface 37 of cylinder head 26. Isolation ring 28 may therefore be designed to allow support member 44 to contact cylinder head 26 at a predetermined fuel pressure. It is now understood that isolation member 46 is the only portion of isolation ring 28 in contact with cylinder head 26 except in instances when fuel pressure applied to fuel injector 24 is at or above the predetermined fuel pressure. Therefore, the material characteristics of isolation member 46 reduce noise at lower to moderate engine loads, which is when noise reduction is most critical. Additionally, the material characteristics of isolation member 46 include insulative potential to isolate heat from being transmitted from cylinder head 26 to fuel injector 24 at lower to moderate engine loads which is the loading internal combustion engine 22 predominantly experiences. When fuel pressure is at its highest levels, support member 44 prevents isolation member 46 from being over compressed.

Recess 48 may be arranged to allow isolation member 46 to deform in order allow for axial compression of isolation member 46 as the axial load applied thereto increases. Isolation member 46 may also be arranged to deform in order to allow for axial compression thereof as the axial load applied thereto increases. This will be described in more detail with the description of the embodiments that follow.

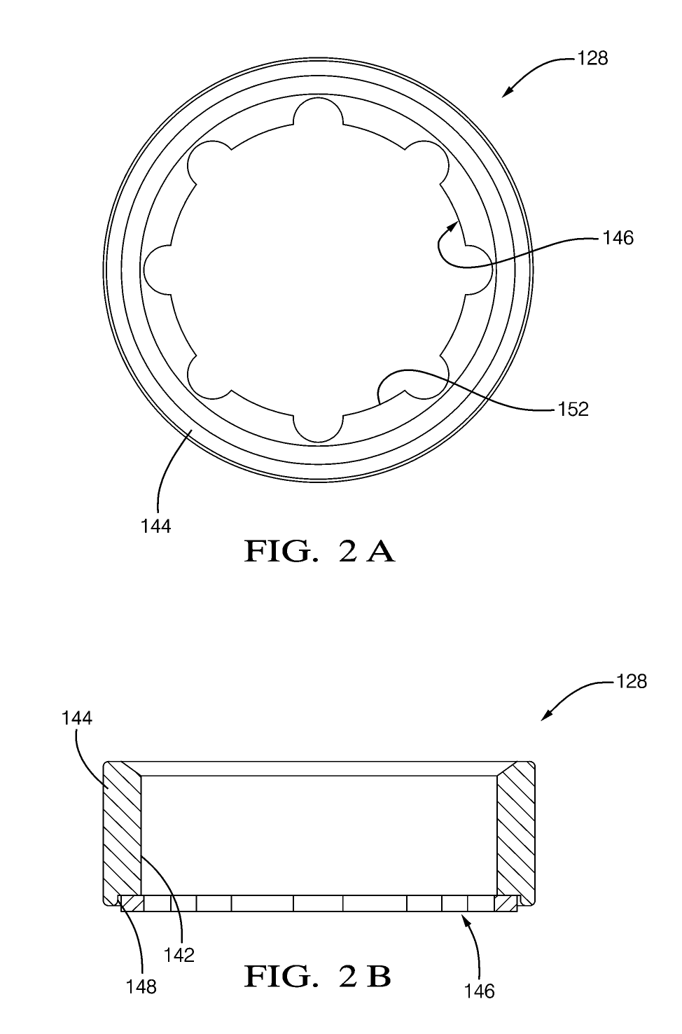

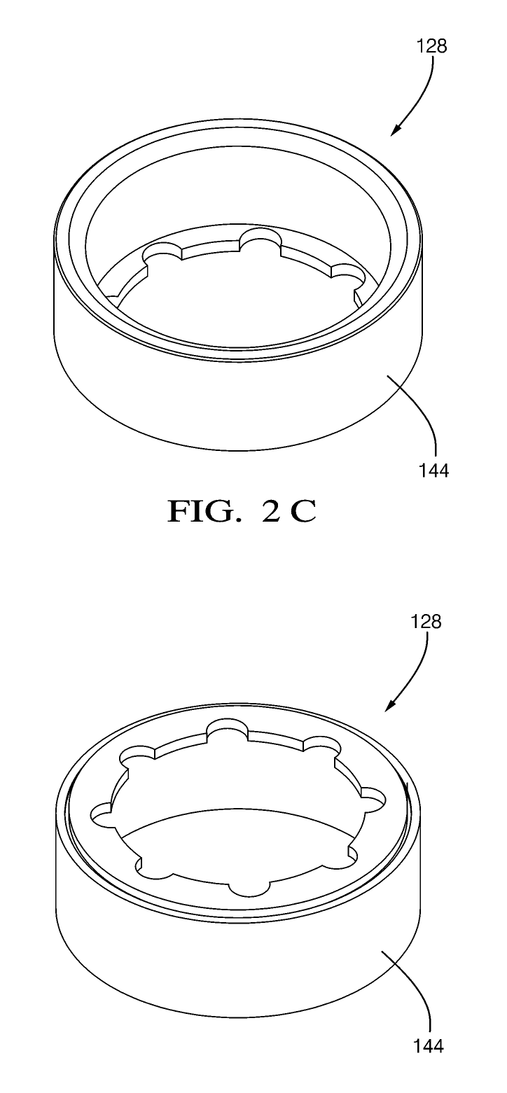

Now referring to FIGS. 2A-2D, a first embodiment of isolation ring 128 is shown in an uncompressed state. Isolation member 146 may include a plurality of protrusions 152 that extend radially inward therefrom. Protrusions 152 serve to form an interference fit with fuel injector 24 in order to retain isolation ring 128 to fuel injector 24 before isolation ring 128 and fuel injector 24 are assembled into cylinder head 26.

Still referring to FIGS. 2A-2D, recess 148 is arranged to allow isolation member 146 to expand radially inward and radially outward when isolation member 146 is compressed axially. This is accomplished by allowing isolation member 146 to expand radially outward because radial clearance is provided between support member 144 and isolation member 146. This is also accomplished by allowing isolation member 146 to expand radially inward because recess 148 extends to center aperture 142, thereby bounding isolation member 146 only radially outward by support member 144.

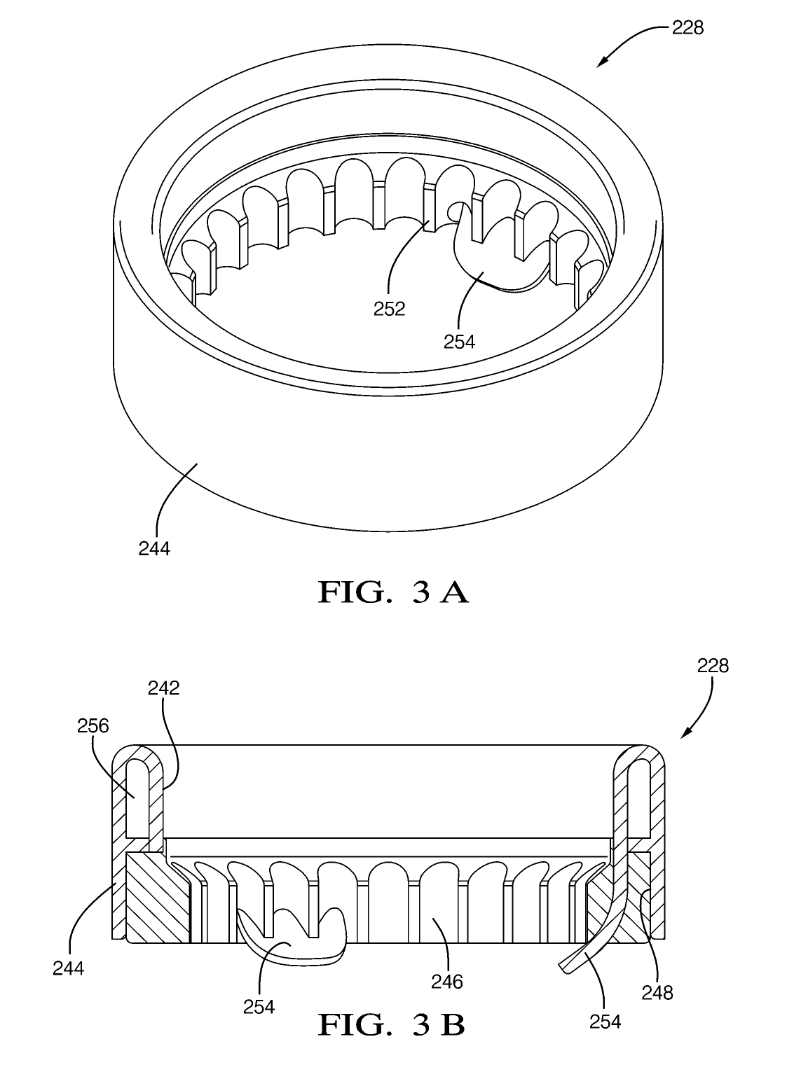

Now referring to FIGS. 3A and 3B, a second embodiment of isolation ring 228 is shown in an uncompressed state. Isolation ring 228 is different from isolation ring 128 of the first embodiment in that the height of isolation member 246 is substantially increased. Isolation member 246 may include a plurality of protrusions 252 that extend radially inward therefrom. Protrusions 252 serve to form an interference fit with fuel injector 24 in order to retain isolation ring 228 to fuel injector 24 before isolation ring 228 and fuel injector 24 are assembled into cylinder head 26. In addition to, or in alternative to protrusions 252, support member 244 may include a plurality of fingers 254 that extend radially inward therefrom. Fingers 254 serve to form an interference fit with fuel injector 24 in order to retain isolation ring 228 to fuel injector 24 before isolation ring 228 and fuel injector 24 are assembled into cylinder head 26.

In the second embodiment, support member 244 may be made of stamped sheet metal. This may result in hollow cavity 256 being formed at the end of support member 244 opposite recess 248. Isolation member 246 may then be injection molded to support member 244. In this way, isolation member 246 may be retained to support member 244.

Still referring to FIGS. 3A and 3B, recess 248 is arranged to allow isolation member 246 to expand radially inward when isolation member 246 is compressed axially. This is accomplished by allowing isolation member 246 to expand radially inward because recess 248 extends to center aperture 242, thereby bounding isolation member 246 only radially outward by support member 244.

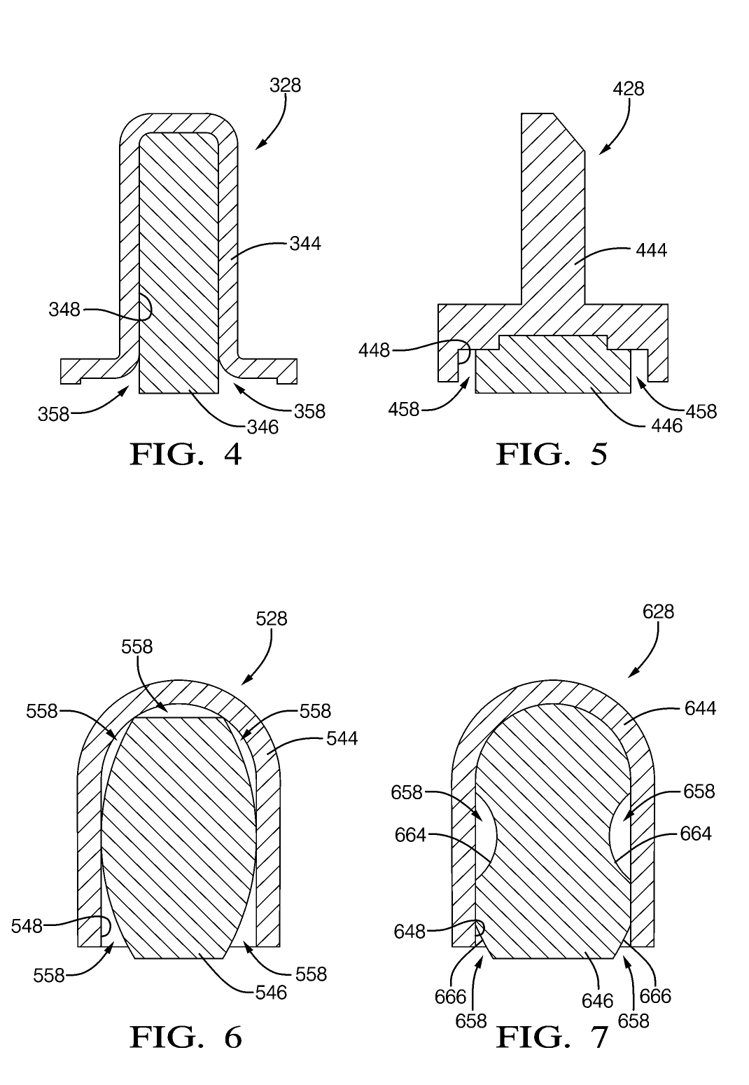

Now referring to FIG. 4, a third embodiment is shown in an uncompressed state in which isolation ring 328 is shown at only a single radial location. In this embodiment, recess 348 bounds isolation member 346 both radially outward and radially inward over most of the axial length of isolation member 346. Recess 348 is arranged to allow isolation member 346 to expand radially outward and radially inward when isolation member 346 is compressed axially. This is accomplished by providing expansion cavities 358 at the open end of support member 344.

Now referring to FIG. 5, a fourth embodiment is shown in an uncompressed state in which isolation ring 428 is shown at only a single radial location. In this embodiment, recess 448 bounds isolation member 446 both radially outward and radially inward over only a small portion of the axial length of isolation member 446. Recess 448 is arranged to allow isolation member 446 to expand radially outward and radially inward when isolation member 446 is compressed axially. This is accomplished by providing expansion cavities 458 at the open end of support member 444.

Now referring to FIG. 6, a fifth embodiment is shown in which isolation ring 528 is shown in an uncompressed state at only a single radial location. In this embodiment, recess 548 bounds isolation member 546 both radially outward and radially inward over a portion of the axial length of isolation member 546. Recess 548 and isolation member 546 are arranged to allow isolation member 546 to expand radially outward, radially inward, and axially upward when isolation member 546 is compressed axially. This is accomplished by providing expansion cavities 558. The barrel-shape cross sectional of isolation member 546 in combination with the straight sides and domed top of support member 544 form expansion cavities 558.

Now referring to FIG. 7, a sixth embodiment is shown in which isolation ring 628 is shown in an uncompressed state at only a single radial location. In this embodiment, recess 648 bounds isolation member 646 both radially outward and radially inward over a portion of the axial length of isolation member 646. Recess 648 and isolation member 646 are arranged to allow isolation member 646 to expand radially outward and radially inward when isolation member 646 is compressed axially. This is accomplished by providing expansion cavities 658. Grooves 664 and chamfers 666 formed in isolation member 646 in combination with the straight sides of support member 644 form expansion cavities 658.

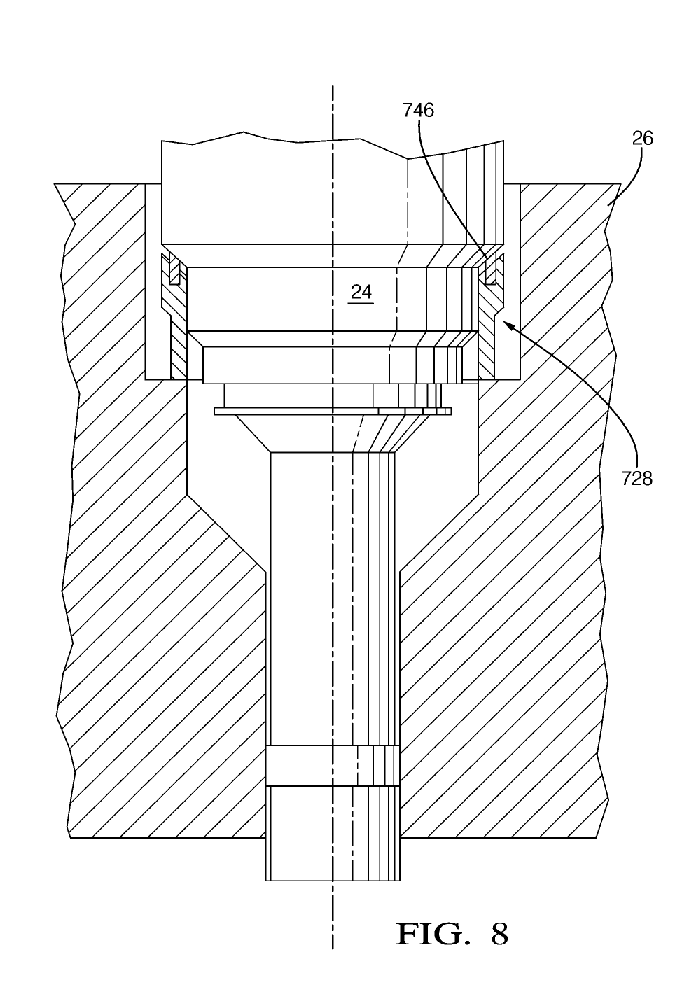

Now referring to FIG. 8, a seventh embodiment is shown in which isolation ring 728 is inverted from the embodiments previously shown. That is, isolation member 746 contacts fuel injector 24 rather than cylinder head 26.

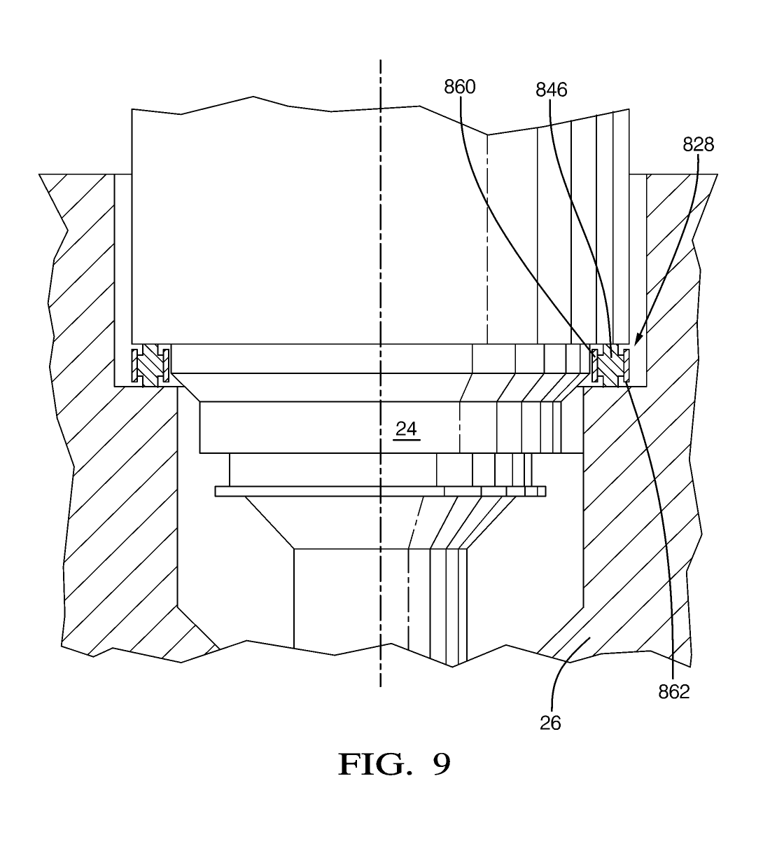

Now referring to FIG. 9, an eighth embodiment is shown in which isolation ring 828 allows isolation member 846 to contact both fuel injector 24 and cylinder head 26. This is accomplished by the support member comprising inner ring 860 and outer ring 862 with isolation member 846 contained therebetween. In the uncompressed state, isolation member 846 extends axially outward from both ends of inner and outer rings 860, 862. Alternatively, but not shown, isolation ring 828 may include only one of the inner and outer rings 860, 862. Also alternatively, but not shown, one or more of inner and outer rings 862 may be integrally formed with fuel injector 24 or affixed thereto in order to form an annular recess for receiving isolation member 846 therewithin.

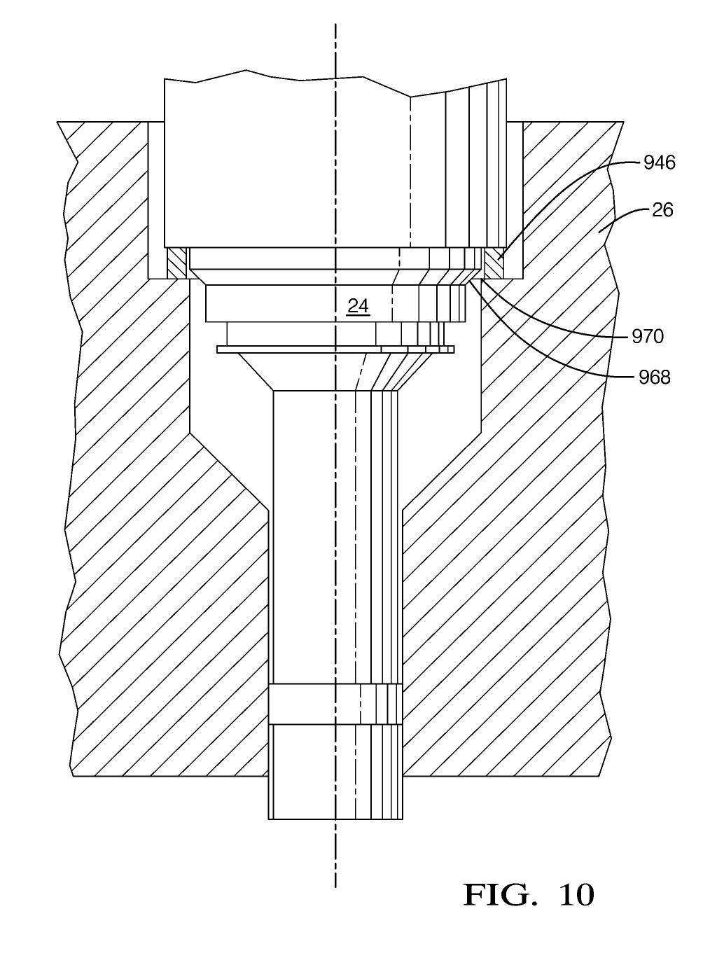

Now referring to FIG. 10, a ninth embodiment is shown in which the isolation ring does not include a support member attached thereto. In this embodiment, the support member is integral with fuel injector 24. In this way, the interaction between features of fuel injector 24 and cylinder head 26 limit the amount of axial compression applied to isolation member 946. Specifically, surface 968 of fuel injector 24 is allowed to come into contact with corner 970 of cylinder head 26 when fuel pressure compress isolation member 946 sufficiently.

While stepped bore 36 has been described as being formed in cylinder head 26 of internal combustion engine 22, it should be now understood that the stepped bore could be located in other elements of the internal combustion which may receive a fuel injector therein. For example, the stepped bore could be formed in the intake manifold of a port injection fuel injection engine. Accordingly, fuel injector-cylinder head assembly 20 may be generically referred to as a fuel injector-engine component assembly where the engine component is any element of the engine with a stepped bore in which the fuel injector is installed.

While the isolation ring has been described as having one isolation member, it should now be understood that multiple isolation members may be used. One example may be a first isolation member for interfacing with the fuel injector and a second isolation member for interfacing with the cylinder head.

While the invention has been described by reference to various specific embodiments, it should be understood that numerous changes may be made within the spirit and scope of the inventive concepts described. Accordingly, it is intended that the invention not be limited to the described embodiments, but rather only to the extent set forth in the claims that follow.

We claim:

1. A fuel injector-engine component assembly for an internal combustion engine, said fuel injector-engine component assembly comprising:
an engine component with a stepped bore defined along an axis, said stepped bore having a stepped bore stop surface facing axially upward;
a fuel injector in said stepped bore and extending along said axis, said fuel injector having a fuel injector stop surface facing axially downwardly and axially opposed to said stepped bore stop surface to define a predetermined annular space, said fuel injector being subject in operation to axial pulses that tend to drive said fuel injector stop surface and said stepped bore stop surface together; and
an isolation ring disposed in said predetermined annular space and axially between said stepped bore stop surface and said fuel injector stop surface for axially isolating said fuel injector from said engine component, said isolation ring comprising:
a rigid support member for limiting the axial motion of said stepped bore stop surface and said fuel injector stop surface together to a predetermined, limited degree; and
a resilient and compliant isolation member located axially between said stepped bore stop surface and said fuel injector stop surface, said isolation member having a sufficient resilience, compressibility, and insulative potential to provide at least one of acoustic and thermal isolation between said fuel injector and said engine component below a predetermined pressure of said fuel injector.

2. A fuel injector-engine component assembly in accordance with claim 1 wherein said support member limits axial compression of said isolation member at or above said predetermined pressure of said fuel injector.

3. A fuel injector-engine component assembly in accordance with claim 1 wherein said support member includes a recess extending axially thereinto for receiving a portion of said isolation member therewithin.

4. A fuel injector-engine component assembly in accordance with claim 3 wherein a portion of said isolation member extends axially away from said support member below said predetermined pressure of said fuel injector.

5. A fuel injector-engine component assembly in accordance with claim 1 wherein said isolation member expands radially in response to axial compression thereof.

6. A fuel injector-engine component assembly in accordance with claim 5 wherein an expansion cavity is formed between said isolation member and said support member to allow radial expansion of said isolation member in response to axial compression thereof.

7. A fuel injector-engine component assembly in accordance with claim 1 wherein said isolation member includes a plurality of protrusions extending radially inward therefrom that form an interference fit with said fuel injector to retain said isolation ring to said fuel injector prior to said fuel injector being received within said stepped bore of said engine component.

8. A fuel injector-engine component assembly in accordance with claim 1 wherein said support member includes a plurality of fingers that extend radially inward therefrom that form an interference fit with said fuel injector to retain said isolation ring to said fuel injector prior to said fuel injector being received within said stepped bore of said engine component.

9. A fuel injector-engine component assembly in accordance with claim 1 wherein one of said isolation member and said support member is in contact with said fuel injector and the other of said isolation member and said support member is in contact with said engine component below said predetermined pressure of said fuel injector.

10. A fuel injector-engine component assembly in accordance with claim 1 wherein said support member is in contact with both said fuel injector and said engine component at or above said predetermined pressure of said fuel injector.

11. A fuel injector-engine component assembly in accordance with claim 1 wherein said isolation member is in contact with said fuel injector and said engine component below said predetermined pressure of said fuel injector.

12. A fuel injector-engine component assembly in accordance with claim 11 wherein said support member is in contact with said fuel injector and said engine component at or above said predetermined pressure of said fuel injector.

13. A fuel injector-engine component assembly in accordance with claim 1 wherein said support member is a first support member and wherein said isolation ring includes a second rigid support member for limiting the axial motion of said stepped bore stop surface and said fuel injector stop surface together to a predetermined, limited degree.

14. A fuel injector extending along an axis for assembly into a stepped bore of an internal combustion engine, said stepped bore having a stepped bore stop surface facing axially upward, said fuel injector comprising:
a fuel injector stop surface facing axially downwardly and axially opposed to said stepped bore stop surface to define a predetermined annular space upon assembly of said fuel injector into said stepped bore, said fuel injector being subject in operation to axial pulses that tend to drive said fuel injector stop surface and said stepped bore stop surface together;
an isolation ring that upon assembly of said fuel injector into said stepped bore is disposed in said predetermined annular space and axially between said stepped bore stop surface and said fuel injector stop surface for axially isolating said fuel injector from said stepped bore, said isolation ring comprising:
a rigid support member for limiting the axial motion of said stepped bore stop surface and said fuel injector stop surface together to a predetermined, limited degree; and
a resilient and compliant isolation member located axially between said stepped bore stop surface and said fuel injector stop surface, said isolation member having a sufficient resilience, compressibility, and insulative potential to provide at least one of acoustic and thermal isolation between said fuel injector and said internal combustion engine below a predetermined pressure of said fuel injector.

15. A fuel injector in accordance with claim 14 wherein said support member limits axial compression of said isolation member at or above said predetermined pressure of said fuel injector.

16. A fuel injector in accordance with claim 14 wherein said support member includes a recess extending axially thereinto for receiving a portion of said isolation member therewithin.

17. A fuel injector in accordance with claim 16 wherein a portion of said isolation member extends axially away from said support member.

18. A fuel injector in accordance with claim 14 wherein said isolation member expands radially in response to axial compression thereof.

19. A fuel injector in accordance with claim 18 wherein an expansion cavity is formed between said isolation member and said support member to allow radial expansion of said isolation member in response to axial compression thereof.

20. A fuel injector in accordance with claim 14 wherein said isolation member includes a plurality of protrusions extending radially inward therefrom that form an interference fit with said fuel injector to retain said isolation ring to said fuel injector prior to assembly of said fuel injector into said stepped bore.

21. A fuel injector in accordance with claim 14 wherein said support member includes a plurality of fingers that extend radially inward therefrom that form an interference fit with said fuel injector to retain said isolation ring to said fuel injector prior to assembly of said fuel injector into said stepped bore.

22. A fuel injector in accordance with claim 14 wherein upon assembly of said fuel injector into said stepped bore, one of said isolation member and said support member is in contact with said fuel injector and the other of said isolation member and said support member is in contact with said stepped bore below said predetermined pressure of said fuel injector.

23. A fuel injector in accordance with claim 14 wherein upon assembly of said fuel injector into said stepped bore, said support member is in contact with both said fuel injector and said stepped bore at or above said predetermined pressure of said fuel injector.

24. A fuel injector in accordance with claim 14 wherein upon assembly of said fuel injector into said stepped bore, said isolation member is in contact with both said fuel injector and said stepped bore below said predetermined pressure of said fuel injector.

25. A fuel injector in accordance with claim 24 wherein said support member is in contact with said both fuel injector and said stepped bore at or above said predetermined pressure of said fuel injector.

26. A fuel injector in accordance with claim 14 wherein said support member is a first support member and wherein said isolation ring includes a second rigid support member for limiting the axial motion of said stepped bore stop surface and said fuel injector stop surface together to a predetermined, limited degree.
